(19) United States
(12) Patent Application Publication
(10) Pub. No.: US 2007/0269249 A1
(43) Pub. Date: Nov. 22, 2007

(54) Apparatus And Method For Decorating Objects

(75) Inventors: Mathias SCHULZ, Bunde (DE); Hans-Dieter NIESTRATH, Hiddenhausen (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Werner Kammann Maschinenfabrik GmbH & Co. KG, Bunde (DE)

(21) Appl. No.: 11/549,308

(22) Filed: Oct. 13, 2006

(30) Foreign Application Priority Data
May 17, 2006 (DE) 10 2006 023 349.2

(51) Int. Cl. B41J 13/12

(52) U.S. Cl. 400/521

(57) ABSTRACT

To increase the throughput capacity when decorating objects, an apparatus and method include at least two transport carriages which are respectively moved by a drive device and on each of which is mounted a respective holder for carrying at least one object. The apparatus has at least one decorating station. The holder of a transport carriage is mounted thereto, movable perpendicularly to the direction of movement of the transport carriage. The at least two transport carriages are guided in at least portion-wise manner on mutually separate carriage tracks.

### BACKGROUND OF THE INVENTION

The invention concerns an apparatus for decorating objects and a method of decorating objects.

European patent application EP 1 088 661 A1 describes an apparatus having a plurality of transport carriages which are respectively moved by a drive device and which have a holder for carrying an object, and a plurality of decorating stations into which the objects are moved by means of the transport carriages and decorated therein. Such objects can be for example CDs, DVDs, credit cards, telephone cards or similar items. The decoration can include any surface treatment such as coating, lacquering and/or applying printing to the object. Particularly when printing on CDs, DVDs, telephone cards or credit cards the usual batch size is between about 500 and 1500 items which are to be printed upon in the shortest possible time. Frequently, an apparatus as indicated above is used for that purpose, but the throughput with such an apparatus is generally comparatively low.

### BRIEF SUMMARY OF THE INVENTION

An object of the present invention is to provide a modified object decorating apparatus such that a higher throughput capacity can be afforded.

A further object of the invention is to provide an apparatus for decorating objects, which enjoys a higher degree of operational flexibility thereby to permit more rational decoration of objects passing through the apparatus.

Yet another object of the invention is to provide a method of decorating objects, which operates in a flexible procedure to afford enhanced efficiency and output.

In accordance with the invention in the apparatus aspect the foregoing and other objects are attained by an apparatus for decorating objects, comprising at least first and second transport carriages which are respectively moved by a drive device and on each of which is mounted a respective holder for carrying at lest one object. The apparatus has at least one treatment station such as a decorating station. The holder of at least one transport carriage is mounted thereto movably perpendicularly to the direction of movement of the transport carriage and the at least two transport carriages are guided in at least portion-wise manner on mutually separate carriage tracks.

It will be seen therefore that the object holder of at least one transport carriage is mounted movably thereto, wherein the direction of movement has at least one component perpendicular to the direction of movement of the transport carriage. With the at least two transport carriages being guided in at least portion-wise manner on mutually separate carriage paths or tracks, such a separation for the carriage tracks can be achieved for example by the transport carriages being guided in parallel relationship.

It may be desirable if the objects pass through the same object path in the decorating operation in the at least one decorating station, independently of the transport carriage. In that respect the action of the different carriage tracks of the transport carriages on object guidance in a decorating station can be compensated by adaptation of the respective holder in such a way that the position of the objects in the holder of different carriages is identical in the decorating operation. In that respect the surface treatment does not have to be specifically set to the respective transport carriage.

Particularly in the case of a linear, that is to say straight carriage guide track, it may be desirable if the apparatus according to the invention comprises two transport carriages which are guided on carriage tracks which extend in parallel and mutually displaced relationship.

It may be particularly appropriate if a holder of a transport carriage is adapted to hold a plurality of objects, wherein there is provided a separate receiver for each of the objects. In that way, a plurality of objects can be passed through the decorating stations with a single carriage, whereby the structural complication and expenditure of the overall apparatus is reduced as there is no need to provide for each object a separate transport carriage which in particular is driven directly. Preferably, in that respect the various object receivers are rigidly associated with each other, that is to say the relative position of the object receivers relative to each other is fixed. Such an object receiver as a recess can be matched to the geometrical shape of the object to be held in order to provide for positively locking engagement with the object so as to ensure that the object is fixed in position in the transport procedure. In the case of a CD/DVD the object receiver can also include a spindle which engages into the central hole in the CD/DVD.

It can be particularly appropriate in that respect if the plurality of object receivers is arranged in succession in the direction of movement of the transport carriage so that the objects can be decorated in succession when passing into a decorating station.

On the other hand, it can also be provided that the plurality of object receivers are arranged in mutually juxtaposed relationship perpendicularly to the direction of movement of the transport carriage, but in that case a plurality of surface treatment devices such as printing heads are to be arranged in mutually juxtaposed relationship in a decorating station in a suitable fashion.

In order to remove the plurality of objects in a holder of a transport carriage in a single working step after decoration of the objects, there can be provided a transfer device which is operable simultaneously to pick up the objects and simultaneously deposit them on a separating carriage which in regard to the object holder can be of a structure like the transport carriage, that is to say it has a holder, with a plurality of object receivers which are arranged in succession in the direction of movement of the separating carriage.

In order to implement loading of a transport carriage with objects to be decorated and removal in a single working step, there can be provided a movable collecting carriage which like the transport carriage has a holder with a plurality of object receivers arranged in succession in the direction of movement. A transfer device is operable to simultaneously pick up the objects held in the holder of the collecting carriage and deposit them in the object receiver of the holder of the transport carriage.

The apparatus according to the invention is suitable for a large number of surface treatments on objects, for example for printing on such objects. In that respect it may be advantageous if it includes at least two decorating stations which are arranged in succession in the direction of movement of a transport carriage through the apparatus. If the holder of a carriage is so designed that, depending on the respective position of the carriage, an object transported thereby is also disposed in one decorating station and another object transported thereby is also disposed in another decorating station, the two objects can be decorated at the same time, for example printed upon. Accordingly, with the movement of an individual transport carriage which moves a plurality of objects arranged in succession, it is possible for example to simultaneously print on a plurality of objects in different printing stations, in which case only a single drive and in particular a direct drive for a carriage is required.

In accordance with a preferred feature of the invention a printing station can carry out one of the multiplicity of conventional printing processes, for example offset printing, screen printing or also contactless printing, such as ink jet printing or laser printing. In that respect the printing process used or the geometrical arrangement of the printing assembly relative to the objects governs whether the object to be printed upon is moved by way of transport by the carriage or is kept stationary during the printing operation in the printing station. In the former case the movement of the object is then to be matched to the printing operation. These are considerations that are familiar to the person skilled in the art and they therefore do not need to be discussed in further detail herein.

It is desirable if the drive device of a transport carriage includes a direct drive such as a linear motor. In that case, depending on the respective configuration involved, the transport carriage can be either the primary part or the secondary part of the linear motor. A structure which has proven to be particularly advantageous here is one in which the coils of the linear motor are arranged in the transport carriage and magnets are arranged in a stationary part of the apparatus. It should be pointed out however that other structures can also be implemented for driving a transport carriage for the apparatus according to the invention, such as a drive by way of a toothed belt, a rack, a screw spindle, a chain or also by means of a pneumatic cylinder.

For moving the holding device on the transport carriage with a motion component perpendicular to the direction of movement of the carriage, there can be provided a displacement means which for example can include a drive coupled to a transmission which at the output side is operatively connected to the holding device. In that case, it is desirable if the displacement means moves the holder in substantially perpendicular relationship to the direction of movement of the carriage. Preferably, there is provided at least one end position for the holder, at which the movement of the holder can be arrested or blocked. That blocking or arresting action affords the advantage that thereafter no force has to be applied in order to keep the holder in the specified position which for example represents a printing position.

Preferably, the displacement means can provide two dead center positions, that is to say reversal positions, for the holder. In that respect, those reversal positions represent end positions for the holder. In that case, it can also be provided that the displacement means is so designed that at least one of those reversal positions has a locking or arresting action. That can be achieved for example by using a thrust crank as the transmission assembly, which is motor-driven and which is operatively connected to the holder to move it between the two reversal positions. Such a thrust crank can also be replaced for example by a crank roller or a slider crank. Preferably, a locking action is achieved in the region of at least one reversal position by virtue of the fact that, because of the transmission arrangement used, the displacement means has a very high step-up ratio there and in the ideal case has an infinitely high step-up ratio so that the holder can be held in the reversal position without the application of a large amount of force or completely without any force.

In that respect, it may be advantageous if the holder near the reversal positions moves at a speed which is low in comparison with the maximum displacement speed of the holder. That measure ensures that the holder approaches the end positions with a low level of impulsion so that scarcely any impacts are transmitted to the apparatus from the holder when the end positions are reached.

The motor of the displacement drive for the holder can be for example a stepping motor, an electromechanical motor, a fluid motor or a piezoelectric motor.

To assist with the movement of the holder on the transport carriage, the apparatus can have an energy storage means which acts at least in each end position. In that respect it can be provided that the energy storage means stores potential energy when the holder is in an end position. That stored energy can then be made available when moving the holder out of an end position, for acceleration thereof. In a particularly advantageous feature the energy storage means can be so designed that it delivers mechanical energy to the holder to accelerate the holder out of an end or reversal position and before an end or reversal position is reached absorbs kinetic energy of the holder in order to retard same. Such an energy storage means can be for example a coil spring or an air spring. The provision of such an energy storage means makes it possible on the one hand to use a small light drive for the displacement means while on the other hand heavy impacts against the entire arrangement when the end position is reached are substantially avoided as the kinetic energy is absorbed for the major part by the energy storage means before the end position is reached. Impulse knocks and vibration caused thereby in the apparatus can be substantially avoided, which otherwise could interfere with the surface treatment for the objects in the decorating stations.

In a desirable embodiment of the apparatus according to the invention it can have an elongate base which for example may be of a parallelepipedic configuration. Arranged at two mutually opposite longitudinal sides are guide means which co-operate with guide means of a complementary configuration for establishing the carriage track of a transport carriage. It will be appreciated that that base can include a plurality of portions. In that respect the co-operating guide means provide for positive guidance of the transport carriage, for example on a linear track.

The structural configuration for a transport carriage in an apparatus according to the invention can be kept comparatively low if it has a vertically extending base plate on which a carrier, such as for example in the form of at least one carrier rail, is arranged, which carries a holding plate which extends substantially perpendicularly to the base plate of the transport carriage. To move the holding plate substantially perpendicularly to the direction of movement of the carriage it can be provided that the carrier is arranged displaceably in the plane of the base plate.

In the method aspect the foregoing and other objects are attained by a method of decorating objects in which at least first and second transport carriages are respectively moved by a drive device and an object is respectively held by a holder which is itself carried by the transport carriage. The holder of a transport carriage is moved substantially perpendicularly to the direction of movement of the carriage and the transport carriages are guided at least in portion-wise manner in mutually displaced relationship. That can provide that carriages which transport the objects during the decorating operation can pass each other, thereby affording a higher degree of flexibility in terms of the configuration of the decorating procedure, which ultimately permits an increase in the throughput.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a diagrammatic side view of a portion of an apparatus according to an embodiment of the invention for printing on objects, showing the principle thereof,

FIG. 2 is a plan view of the FIG. 1 apparatus,

FIG. 3 shows the apparatus of FIG. 1 in an end view taken along line III-III with a side view of two transport carriages,

FIG. 4 is a front view perpendicular to the direction IV shown in FIG. 3 illustrating a transport carriage as shown in FIG. 3,

FIG. 5 is a view similar to that shown in FIG. 1 with mutually displaced carriages,

FIG. 6 is a diagrammatic plan view showing the principle of the input and output stations of the printing apparatus according to an embodiment of the invention in a first operating situation,

FIG. 7 is a diagrammatic plan view of the input and output stations of FIG. 6 in a second operating situation, and

FIG. 8 is a diagrammatic plan view of the input and output stations of FIG. 6 in a third operating situation.

### DETAILED DESCRIPTION OF THE INVENTION

An apparatus according to the invention for decorating objects, which is designed in this specific case for printing on CDs or DVDs, is described hereinafter by means of an embodiment.

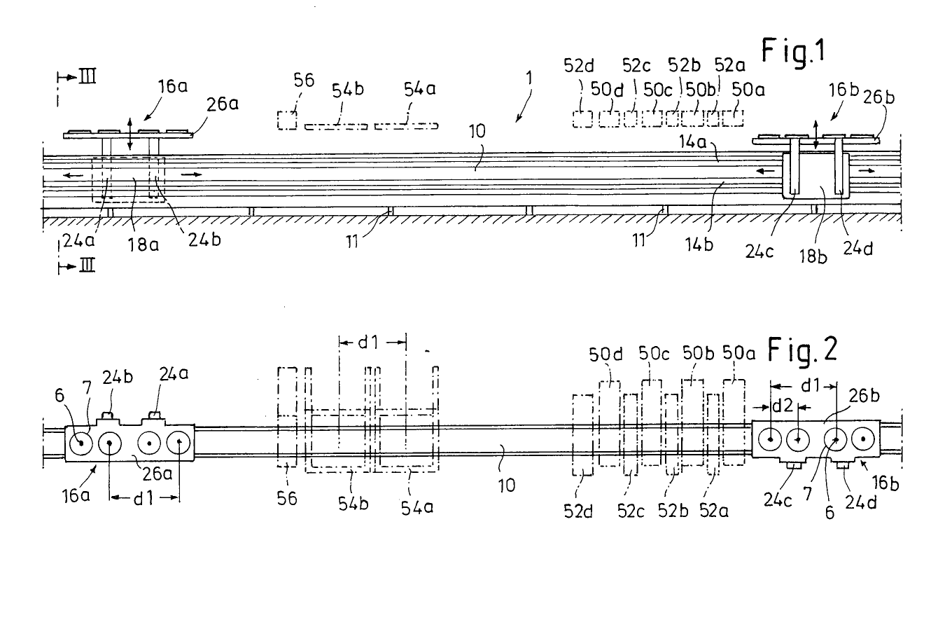

A portion of such a printing apparatus 1 is shown as an overview in FIGS. 1 and 2, with FIG. 1 showing the apparatus as a side view and FIG. 2 as a plan view. The apparatus is of an elongate rectilinear structure which is established by a base element 10 which is substantially parallelepipedic and which is supported on the floor with legs 11. A respective carriage 16a, 16b is provided along the two vertical longitudinal sides of the base element 10. Each carriage 16a, 16b is mounted movably with a base plate 18a, 18b substantially along the entire longitudinal extent of the base element 10. Mounted on the respective base plate 18a, 18b are carrier rails 24a, 24b; 24c, 24d which are displaceable in a vertical direction and which each carry a holding plate indicated at 26a, 26b in FIG. 1.

As can be seen in particular from FIG. 2 that holding plate has a plurality of object receivers 6 which are arranged in succession in the direction of movement of the respective carriage. In the described embodiment the receivers each have a short pin or spindle which just engages into the respective central hole in a CD or DVD. Accordingly, the mobility of the carriers 24a, 24b in the vertical direction means that the respective holding plate 26a, 26b which is fixed rigidly to the carriers is adjustable in respect of height. As can be seen from FIGS. 1 and 2 the carriers 24a, 24b; 24c, 24d are respectively fixed to a longitudinal side of the holding plates 26a, 26b and extend substantially perpendicularly to the direction of movement of the respective base plate 18a, 18b.

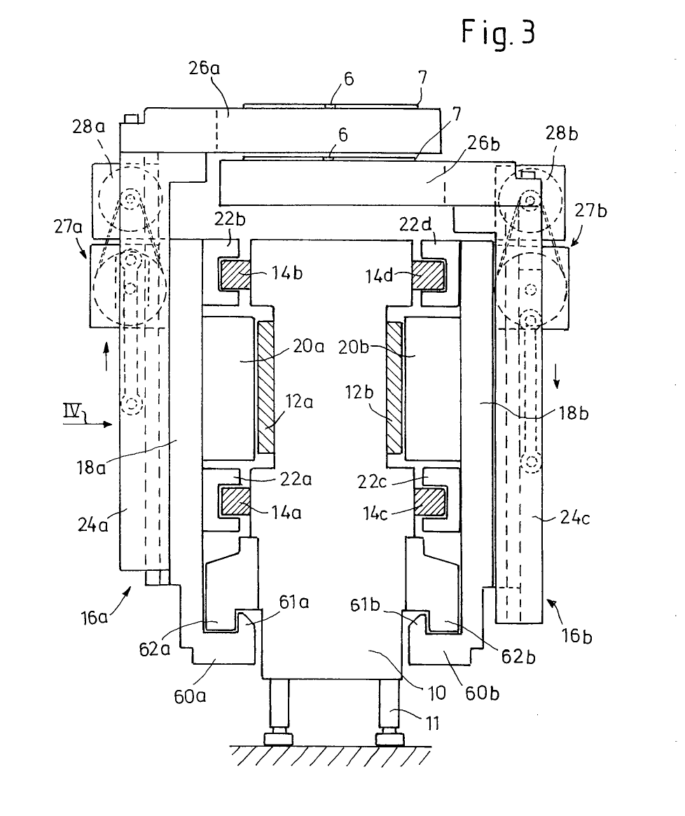

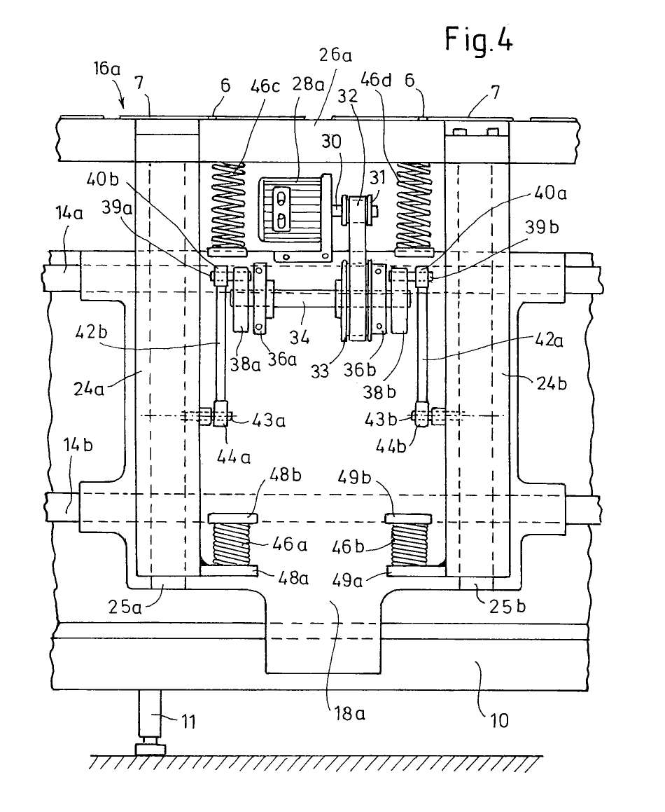

The two carriages 16a, 16b are of a mirror image configuration relative to the plane of the drawing, in relation to FIG. 1. In this case the carriages are guided and held on the base element 10 on vertically spaced guide rails extending in the longitudinal direction of the base element 10. The two carriages are moved by direct drives which operate independently of each other and which in the described embodiment are in the form of linear motors. In that case however the movement of the carriages in the longitudinal direction of the base element and the movement of the holding plates 26a, 26b in the vertical direction are matched to each other. Details concerning the drives for the carriages and the displacement drives for the holding plates are discussed hereinafter with reference to FIGS. 3 and 4.

In the embodiment of the invention illustrated in the Figures the apparatus 1 is a printing apparatus designed for implementing four-color printing, wherein prior to the actual printing process a primer is applied to the objects and after the actual printing process the surface is sealed by applying a layer of lacquer. The primer and the lacquer are respectively applied to the CD or DVD by a screen printing station clearly shown at 54a, 54b while for the four-color printing operation there are four ink jet printing head stations at 50a through 50b which are arranged in succession in the direction of movement of the carriages and which are respectively provided for printing on the object with a respective one of the four base colors. Provided between the individual printing stations in the direction of movement of the carriages is a respective drying station at 52a through 52d in each of which the applied printing ink is initially dried by means of a drying unit such as a UV tube prior to printing with the following ink.

For the operations of applying the primer, applying the printing or applying the lacquer to a given object which is deposited in one of the receivers 6, the respective carriage travels with the specific object in question into the decorating station in which the respective surface treatment is carried out, for example by a screen printing operation. The respective carriage which carries the object which has just been subjected to surface treatment is stationary in the screen printing stations as a screen printing doctor which is not shown in the Figures is moved perpendicularly to the direction of movement of the transport carriages 26a, 26b. In contrast thereto, printing heads (not shown) of the printing stations 50a through 50d are fixed during the printing operation and the respective object to be printed such as a CD or DVD is moved below the printing head at a speed suited to the printing operation. For that purpose, the lengthwise position of the carriage and thus the actual position of the object or objects are detected by means of a measuring arrangement so that the movement of the carriage under the printing head can be synchronized with the printing operation.

The ink jet heads used each have at least one printing line which is arranged perpendicularly to the direction of movement of the carriage and which is of an extent which is no less than the width of the region of the object which is to be provided with the decoration, in transverse relationship with the transport direction thereof. Such a print line comprises nozzles which are spaced in the longitudinal direction of the print line and from which the ink is ejected. A suitable configuration of such a printing head and adaptation of the movement of an object to the printing operation is described in detail in European patent application EP 1 088 661 A2, to which reference is directed for incorporation of the content thereof herein and for the avoidance of repetition.

In the described embodiment of the present invention, a plurality of, and more specifically here four, objects are moved simultaneously with a single transport carriage. Accordingly, detecting the actual position of the transport carriage also involves determining the actual position of the four objects on the carriage as the objects are held in predetermined fashion in the receivers 6 of the holding plate 26a, 26b. If, for example, the carriage shown on the right-hand side in FIG. 2 is moved towards the left through the successively arranged printing stations 50a through 50d or through the associated drying stations 52a through 52d, the four objects arranged on the holding plate 26b are successively printed upon in the respective printing stations and dried in the drying stations. Depending on the respective position of the carriage in given operation situations, all of the four objects are subjected to surface treatment, that is to say dried or printed upon, at the same time, in different stations. The operating parameters of the drying stations 52a through 52d such as the intensity of the light or the residence time of the object to be dried are therefore matched to the printing speed in the printing stations 50a through 50d so that a first object which is to be dried in the drying station and a second object which is to be printed in a printing station can be moved at the same speed. That is, the prerequisite for both objects being movable with the same transport carriage through the successive arrangement of the printing stations and the drying stations.

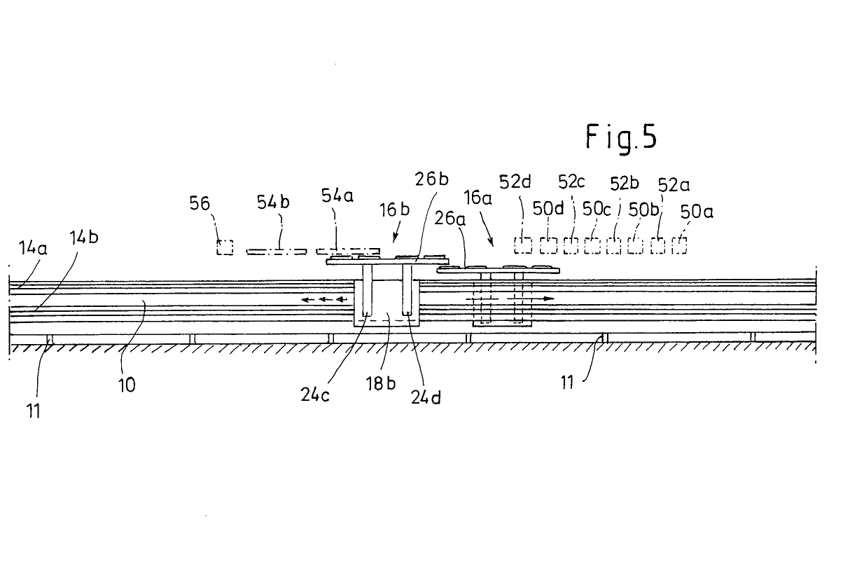

For the printing operation the two carriages 26a, 26b can be moved in succession into the stations, in which case the object paths, that is to say the path described by an object which passes through a station during the printing operation, is the same for all objects. The configuration according to the invention of the printing apparatus described herein means that it is possible for the two carriages and therewith the holding plates 26a, 26b to be guided past each other. In that respect, the movement of each of the two carriages is not restricted by the position or movement of the respective other carriage as the two holding plates 26a, 26b can be so adjusted relative to each other that they do not collide. By way of example, the two carriages can be so arranged in position that the two holding plates 26a, 26b are disposed within the same printing station, but only one of the holding plates will be in a printing position, that is to say in a position in which printing is applied to an object held by a receiver 6. In comparison, in that situation the holding plate of the other transport carriage is in a different horizontal plane, as will be discussed in greater detail hereinafter with reference to FIG. 5.

Objects of the two carriages, which are held by the receivers 6 of the holding plates 26a, 26b, can however be simultaneously subjected to surface treatment, that is to say here printed upon and/or dried, in different stations.

Before such a procedure is described, reference will be made hereinafter to FIGS. 3 and 4 to describe in greater detail the support of a carriage on the base element 10 and the displacement device for moving a holding plate relative to the respective carriage base plate.

FIG. 3 shows an end view of the apparatus according to the invention. The apparatus for decorating objects has an elongate, substantially parallelepipedic base 10 which is supported on the floor with support legs 11 and above which are arranged treatment stations which are not illustrated here for objects to be decorated. Provided at each of the two longitudinal sides of the base 10 is a respective stationary part 12a, 12b of a linear motor, which parts extend on the base 10 over the longitudinal extent thereof. Disposed on the base 10 above and below each stationary part 12a, 12b of the linear motor is a respective guide rail 14a, 14c; 14b, 14d which each extend parallel to the stationary parts 12a, 12b of the linear motor.

Provided at each side of the base 10 is a carriage 16a, 16b which is arranged displaceably along the base 10. The carriages each have a carriage base plate 18a, 18b. At its side towards the base 10 each of those plates carries a movable part 20a and 20b respectively of the linear motor, which co-operates with the respectively associated stationary part 12a and 12b to drive the carriage in conventional manner. Disposed on the plate 18a, 18b below and above the respective movable part 20a, 20b of the linear motor are two guide shoes 22a, 22b and 22c, 22d respectively, which co-operate with and embrace the respective oppositely disposed guide rail 14a, 14b and 14c, 14d.

In order to provide a measuring system with which the actual position of the respective carriage in the longitudinal direction relative to the base 10 can be detected, the two carriage base plates 18a, 18b have U-shaped portions 60a, 60b which are directed inwardly towards the base 10 and which each provide a respective inner limb 61a, 61b on which an optical sensor which is not shown here is arranged. A respective protrusion 62a, 62b projects into each of the U-shaped portions 60a, 60b of the carriage base plates. The protrusions 62a, 62b, like the guide rails, extend substantially over the entire length of movement of the carriages in the longitudinal direction of the base 10. The protrusions 62a, 62b, on the side directed towards the sensor mounted on the respective limb 61a, 61b, have a scale which is optically sensed by the sensor. The measuring system is designed to ascertain the actual position of the respective carriage with a degree of accuracy of better than 1 μm.

The two transport carriages 16a, 16b each include a respective holding plate 26a, 26b which is mounted displaceably on the respective base plate 18a, 18b of the associated transport carriage 16a, 16b. For that purpose each carriage includes carrier rails 24a, 24c which carry the respective holding plate 26a, 26b and which are fixedly connected thereto and which are movable by means of a displacement device 27a, 27b perpendicularly to the direction of movement of the carriages.

Reference is now made to FIG. 4 showing the transport carriage 16a which is held by the base 10 and which includes the carriage base plate 18a and the two carrier rails 24a, 24b. The holding plate 26a which has a plurality of object receivers 6 for receiving objects to be decorated is screwed to the carrier rails. The carrier rails 24a, 24b are movably connected to the carriage base plate 18a in such a way that they are movable vertically with respect to the base plate 18a. The movement of the holding plate 26a or the carrier rails 24a, 24b takes place with positive guidance in respect of the rails 24a, 24b in mutually spaced guide rails 25a, 25b perpendicularly to the direction of movement of the transport carriage 16a, by the guide rails 25a, 25b respectively engaging into portions of a complementary configuration of the associated carrier rail 24a, 24b.

To move the holding plate 26a relative to the carriage base plate 18a, the described embodiment has a pneumatic pivotal motor 28a which is fixed to the base plate 18a of the carriage. In its interior, in a structure which is not shown here, the pneumatic motor 28a has a pivotal vane which can be rotated into one of two chambers by a supply of air. The pivotal angle is steplessly adjustable, with end position adjustment being effected by means of stop screws co-operating with an abutment lever on the pivotal vane for establishing the two end positions. End position damping is effected for example with a damping plate or a shock absorber. Adjustment of the two end positions will be described in greater detail hereinafter.

The axis of the pivotal vane extends in the form of a drive shaft 30 out of the pneumatic pivotal motor 28a. By way of a toothed wheel 31 it drives a toothed belt 32 which in turn moves a shaft 34 by way of a toothed wheel 33. A predetermined step-down ratio is set by suitable selection of the toothed wheels 31, 33 on the drive shaft 30 and the shaft 34 respectively. The shaft 34 is supported in two ball bearing carrier members 36a, 36b which are of a plate-like configuration and which are fixed rigidly to the carriage base plate 18a. The shaft 34 extends beyond the ball bearing carrier members 36a, 36b, with a crank 38a, 38b being rigidly fixed to each of the two ends thereof. In that respect the two cranks are driven in a synchronous rotary movement by the shaft 34.

Arranged in the region of the outer radial edge of each of the cranks 38a, 38b is a respective pin 39a, 39b which carries the bearing of a link head 40a, 40b which represents one of the two ends of a thrust rod 42a, 42b. At their second ends the thrust rods 42a, 42b have respective link heads 44a, 44b, the rotary bearings of which receive pins 43a, 43b which extend laterally out of the two carrier rails 24a, 24b. The rotation of the cranks 38a, 38b causes the thrust rods 42a, 42b and therewith also the carrier rails 24a, 24b secured thereto to be moved synchronously. If for example the cranks 38a, 38b shown in FIG. 4 rotate out of the plane of the drawing, the thrust rods 42a, 42b and therewith the carrier rails 24a, 24b are moved downwardly. In that case, positive guidance for the carrier rails is implemented in such a way that the movement of the carrier rails is within the plane of the drawing.

The described displacement arrangement establishes two reversal positions or dead points for the carrier rails and thus the holding plate 26a. The motor 28a rotates the cranks 38a, 38b from the top dead center point shown in the drawing downwardly into the bottom dead center point. While the bottom dead center point represents a stable equilibrium position the top dead center point is an unstable working point. At the top dead center point the slightest pivotal movements of the cranks mean that, as a result of a vertically downwardly directed force acting on the carrier plate 26a, the entire assembly which is movable relative to the base plate, consisting of the carrier plate and the carrier rails 24a, 24b, is moved downwardly if the motor 28a does not produce a counteracting force to retain the top dead center position. In the region of the top dead center point the force transmission action by virtue of the cranks is infinitely high so that the motor 28a only has to apply a very low level of torque to fix, that is to say arrest, that dead center position.

In the described embodiment the cranks are in the form of symmetrical cranks 38a, 38b. In that respect the distance of the translatory movement of the carrier rails and thus the heightwise displacement of the holding plate 26a is established by double the spacing between the fixing point of the pin of the one link head 40a, 40b to the crank 38a, 38b, to the center of the shaft 34.

The two end positions as adjusted in the pivotal motor 28a, by way of the stop screws, correspond to the two dead center positions of the cranks 38a, 38b. To reach those two reversal positions the pivotal vane in the motor 28a of the described embodiment rotates through about 180°. In that respect the ratio of the toothed wheels 31 and 33, which is shown in FIGS. 3 and 4, is not true to scale. As already described hereinbefore, when the two end positions of the pivotal vane are reached the impact of the abutment lever against the stop screws is damped by means of an end position damping action so that, by virtue of the low mass of the pivotal vane, when the top or bottom dead center point position is reached, scarcely any impacts are transmitted to the carrier plate 26a, which could otherwise cause vibration of the carrier plate and in that way interfere with the printing operation.

A substantial part of the kinetic energy of the entire assembly consisting of the carrier plate and the runner rails is absorbed by mechanical compression springs 46a through 46d which are respectively connected at one end to the base plate 18a and at the other end to a rail 24a, 24b and the holding plate 26a respectively. The springs are clamped in position in such a way that in any operating situation they have a spring bias and thus act as a compression spring. The lower springs 46a, 46b are respectively clamped between two counterpart plates 48a, 48b and 49a, 49b. In that arrangement the lower counterpart plate 48a, 49a is fixed rigidly to the respectively associated carrier rail 24a, 24b and the upper counterpart plate 48b, 49b is rigidly fixed to the carriage base plate 18a. As is apparent from FIG. 4 the upper compression springs 46c, 46d are fixed with their one end to the carriage base plate 18a and with their other end in each case directly to the holding plate 26a.

As the cranks are in their top dead center position in the position of the holding plate 26a shown in FIG. 4, only a slight torque to be applied by the pneumatic motor 28a is required to hold the carrier plate 26a in the illustrated upper reversal position in a stable condition, even under the action of an external force, for example during the printing operation. If the cranks are moved out of the specified top dead center position, the biased compression springs 46a through 46d support the downward movement of the holding plate, with the lower pairs of springs counteracting the upper pairs. In the described situation the lower springs 46a, 46b produce the greater force as they have a higher level of spring bias than the upper springs 46a, 46d. While the lower springs 46a, 46d relax while maintaining their spring bias, the bias in the upper springs 46c, 46d is increased until the bottom dead center point position of the cranks 38a, 38d is reached. The described spring arrangement, on the one hand, assists with the movement of the holding plate out of a first dead center position by virtue of the spring forces acting thereon and, on the other hand, it retards the movement when the other dead center point position is reached. A particularity with the embodiment illustrated in FIG. 4 is that the drive, in the region of the two dead center point positions, transmits to the holding plate 26a a motion component tending towards zero in the direction of movement of the holding plate 26a.

The described displacement drive for heightwise adjustment of the holding plate 26a, 26b provides two end positions which by virtue of the use of the thrust crank are set up as reversal positions and represent locking positions which can be maintained with the application of a small amount of force by the motor 28a. In other embodiments the displacement motor could also be an electric motor such as a stepping motor or another actuator. It is particularly desirable if at least one end position in respect of the heightwise displacement has a locking position which is precisely defined and which is maintained during the printing operation. The use of an energy storage means, such as a spring, means that a substantial part of the energy required for movement of the holder can be taken from the energy storage means for the purposes of accelerating the holding plate and can be returned to the energy storage means again in the retardation phase. That means that the drive motor can be kept light and small. Furthermore, this means that the kinetic energy which is to be absorbed in the motor retardation phase is very low so that only low forces act in the abutment damping processes and thus act on the carriage or the entire apparatus. In an embodiment which is not illustrated here, instead of a thrust crank drive, the apparatus has a cam roller drive or a thrust slider crank arrangement, which in a similar manner both provide two reversal positions for the holding plate, with a locking action.

The way in which the carriages 16a, 16b are supported on the base element 10 and the heightwise displacement of the holding plates 26a, 26b having been described, the process of printing on objects on a single carriage 16a in the apparatus 1 according to the invention will firstly be described, for the sake of clarity of the presentation thereof, before the mutually matched movement of the two carriages is discussed.

The transport carriage 16a firstly moves towards the right from the position shown in FIG. 2 in such a way that the object receiver which is last in the direction of travel, or the CD or DVD supported therein, is in a printing position in the screen printing station 54b. That printing position is distinguished on the one hand by virtue of a prescribed position for the CD or DVD in question in the direction of movement of the carriage to the printing station, and on the other hand by virtue of the fact that the holding plate 26a is in the upper reversal position which, as described, represents a locking position. There the operation of applying primer to the CD or DVD which is first in the direction of movement is carried out as described above with the carriage in a stationary condition. Thereafter, the carriage moves further towards the left by a predetermined distance until the object receiver which is second in the direction of movement, or the second CD or DVD, is in a printing position in the screen printing station 54b so that the CD or DVD can be primed, with the carriage in a stationary condition. That procedure is continued until the last CD or DVD which trails in the currently prevailing direction of movement comes to lie in the above-mentioned printing position in the screen printing station 54b so that that last CD or DVD can also be primed.

As now all CDs on the holding plate 26a have been primed, the carriage 26a moves at a uniform speed through the drying station 56 which has a UV tube for drying the applied primer. In contrast to the printing operation in the screen printing station 54b, drying of the CDs or DVDs in the station 56 accordingly takes place while the carriage is moving through the station.

After the holding plate 26a, by virtue of the movement of the carriage, has been moved over its entire lengthwise extent through the drying station 56, it has again reached the position shown in FIG. 2. Now, as described with reference to FIG. 4, the holding plate 26a is moved downwardly into the lower reversal position and the carriage is moved towards the right again by means of the linear motor, in which case it passes through all treatment stations 56, 54a, 54b, 50a through 50d and 52a through 52d, those stations being inactive when the carriage 16a or the holding plate 26a thereof moves through the stations. The carriage 16a reaches the lengthwise position shown in FIG. 2 by the carriage 16b on the base element 10, in which respect the latter carriage 16b is to remain disregarded at this juncture for the present description of the principles of the printing operation in relation to the carriage 16a. The holding plate 26a of the carriage 16a is now moved from the lower locking position by actuation of the pivotal motor, with the assistance of the energy stored in the springs 46a through 46d, into the upper dead center point position which represents the horizontal printing and drying position of the holding plate 26a. The carriage now moves the holding plate 26a or the CDs or DVDs held in the object receivers 6 respectively uniformly through the successively arranged printing stations 50a through 50d, each with a respective stationary ink jet printing head. After a respective one of the colors has been applied to a CD or DVD, preliminary drying of that color takes place in the drying station 52a through 52d which is disposed downstream of that printing station, before the respective CD or DVD passes through the next following printing station. When the carriage 16a has passed through the printing station and the drying station cascade 50a through 50d and 52a through 52d over the entire longitudinal extent of the carriage then four-color printing for the four CDs or DVDs arranged on the holding plate 26a has been concluded. They are then moved again into the lacquering station 54a by a stepwise movement of the carriage and lacquered when the carriage is in a stationary condition. After all four CDs or DVDs have been successively lacquered in the lacquering station 54a, they are then successively moved uniformly through the drying station 56. Thereafter, the printing operation for the CDs or DVDs on the carriage 16a has been concluded and the CDs or DVDs can be removed from the holding plate 26a, as will be described in greater detail hereinafter.

The configuration of the printing apparatus according to the invention provides that it can be operated with a plurality of carriages which move simultaneously and which each transport a plurality of objects such as CDs. It should be emphasized that, for example, an embodiment having three or four carriages is also in accordance with the invention, in which case then a plurality of carriage tracks can be arranged at a longitudinal side of the base of the apparatus, the tracks, for example, being at differing spacings relative to the center line of the base element.

As already discussed in detail hereinbefore the printing station 1 according to the invention as shown in the Figs. has two such carriages which are each movably mounted to a respective longitudinal side of the base element 10. Each of those carriages can carry out the printing procedure just described hereinbefore in the apparatus, in which respect collisions can now be avoided by virtue of the fact that, when the carriages move past each other, the respective holding plates 26a, 26b can be displaced in respect of their height relative to each other by means of the respective displacement device 27a, 27b, as shown in FIG. 3. Such a situation is illustrated in FIG. 5. The carriage 16b is just disposed in the direction of movement with its first receiver in the printing position in the lacquering station 54a while the carriage 16a is moving in the opposite direction in FIG. 5 towards the right in order for the above-described four-color printing operation to be carried out. So that the carriage 16a can pass the carriage 16b, the holding plate 26a has moved to the lower reversal position with which the carriage 16a also passes through the printing stations 50a through 50d. After attainment of the end position at the right-hand side in the drawing, the holding plate 26a is moved as described into its printing position, that is to say into its upper reversal position, so that the four-color printing process can then be carried out. At the same time, the carriage 16b moves further towards the left into the opposite end position where the CDs or DVDs which have been printing upon, lacquered and dried are removed. At that removal location, the receivers 6 are also fitted with CDs or DVDs which have not yet had printing applied thereto, so that the entire printing process can begin again from the beginning.

As can be seen in particular from FIG. 2, the arrangement of the receivers 6 on the carriages 16a, 16b is adapted to the spacing d1 of the two screen printing stations 54a, 54b, for the situation where no clear lacquer has to be applied to the CDs or DVDs in the screen printing station 54a after the above-described operation of applying four-color printing to the CDs or DVDs has been carried out. In that respect the two screen printing stations 54a, 54b can then be used for applying the primer. For that purpose, the first and third or the second and fourth receivers respectively arranged in the direction of movement of the carriages are so spaced on the holding plate that the center points thereof involve a spacing d1 which precisely corresponds to the spacing d1 of the printing positions in the two screen printing stations 54a, 54b, as shown in FIG. 2. In that way, the primer can be applied simultaneously in each case to the first and third CDs or DVDs on the receivers of the carriage and subsequently, after transport movement of the carriage by the distance d2, the primer can be applied to the second and fourth CDs or DVDs.

In certain situations it may be that the resolution of the ink jet printing heads used in the printing stations 50a through 50d is not sufficient for the print quality required. In that case, the apparatus provides that two half-images are applied for each color. After the first four-color half-image has been printed, the carriage moves back again into the right-hand starting position shown in FIG. 2 in respect of the carriage 16b, the printing heads are displaced by half a pixel spacing transversely with respect to the direction of movement of the carriage and then the second half-image is applied for all four colors.

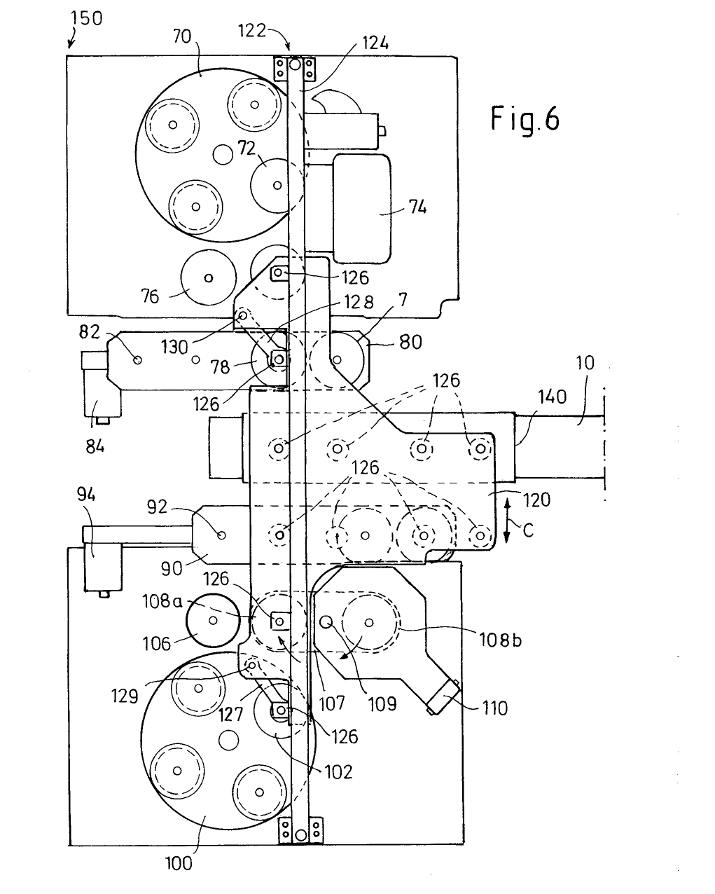

Reference is now made to FIGS. 6 through 8 to describe the configuration of the part of the printing apparatus according to the invention for fitting the receivers 6 with objects to be printed upon, on the carriages, or for removal of the printed objects from the receivers of the carriages. FIGS. 6 through 8 show an input and output station generally indicated at 150 adjoining at the left the base element 10, which is shown in FIGS. 1 and 2. The base element 10 extends into the input and receiving station so that a respective carriage 16a, 16b can move thereinto. The parking position of the respective transport carriage or the respective holding plate in the input and output station is denoted by reference numeral 140. A carriage fitted with objects such as CDs which have been printed upon moves in that position of its holding plate.

The input and output station 150 has an input portion arranged in the upper region in FIGS. 6 through 8 and an output portion arranged in the lower region of the Fig. CDs which are to be printed upon are stacked on four CD input plates 72 which centrally have a long spindle extending through the central hole of the CDs. The CD input plates 72 are arranged in circumferential relationship on an input carousel 70. After the CDs which have been deposited on one of the CD input plates 72 are removed, the input carousel rotates to the next filled CD input plate which is thereupon emptied. The input portion further includes a collecting carriage 80 having a receiving plate which is identical to that of a transport carriage. In that respect, the collecting carriage also has CD receiver 82 which are arranged relative to each other on the receiving plate in the same manner as that of the transport carriage. The collecting carriage can be moved stepwise by means of a stepping motor 84 parallel to the longitudinal extent of the parking position 140 of a transport carriage.

In a similar manner, the output region has a separating carriage 90 which in turn like the collecting carriage has CD receivers, wherein the spacing of the receivers is in turn identical to that of a transport carriage. The separating carriage is also movable by way of a stepping motor 94 parallel to the collecting carriage or transport carriage respectively. The collecting carriage and the separating carriage are moved independently of each other with a stepwise movement in the described embodiment. In that case, the stepping distance is determined by the spacing of two receivers 82, 92 on the respective carriage 80, 90.

As shown in FIGS. 6 through 8, the collecting carriage and the separating carriage are displaced only within the input and output station.

The output region has a receiving carousel 100 which has four CD receiving plates 102 in circumferentially spaced relationship. Each plate again has a spindle on which the discharged CDs are arranged in a stack row. When a CD receiving plate is filled as far as the end of the respective spindle, the carousel 100 rotates to the next CD receiving plate, which is subsequently filled with printed CDs.

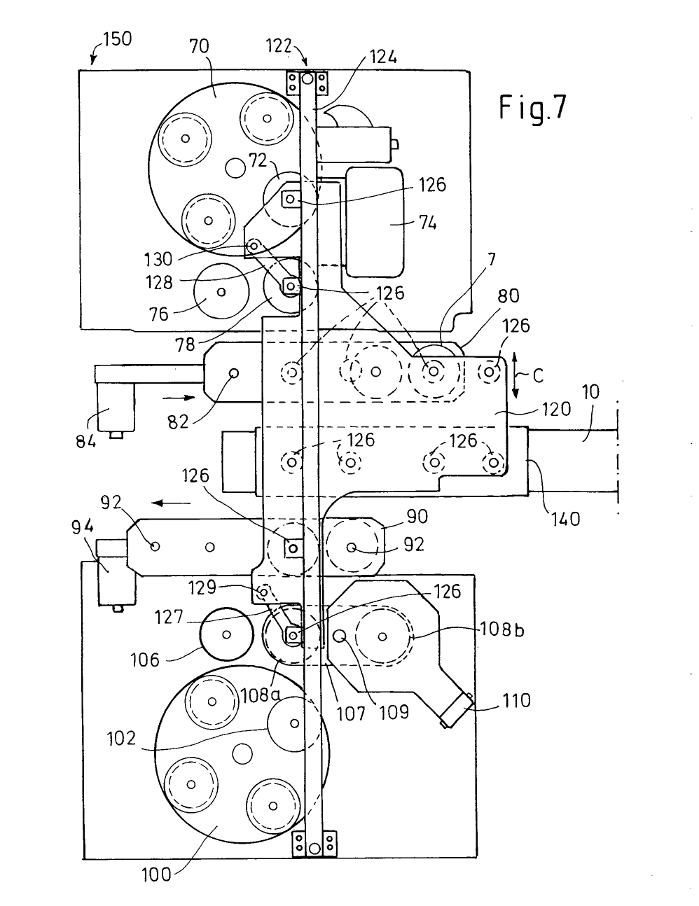

In order to ensure that a CD disposed in the input carousel 70 suits the printing operation which has just been performed, each input CD is subjected to what is to referred to as an IdentCheck. That operation is implemented with the IdentCheck plate indicated at 78 in FIG. 7 on which the CD removed from a CD input plate is firstly laid and on which the identity of the CD in question is subsequently ascertained. For that purpose, each CD has a code marking which uniquely identifies the data content. If in the operation of checking the identity of the respective CD it is found that it does not correspond to the set printing operation, the CD is deposited on the reject plate 76.

An operation referred to as a PrintCheck for checking the print quality is carried out in a similar manner in the output region. For that purpose, the CD to be checked is placed on a PrintCheck carousel 107 which is of an oval configuration and which has two PrintCheck plates 108a, 108b in symmetrical relationship with an axis of rotation 109 of the carousel. The CD to be checked is placed on the plate which is identified by reference numeral 108a. Thereafter, the PrintCheck carousel 107 rotates through 180o with the axis of rotation 109 perpendicular to the plane of the drawing, whereby the CD passes into the detection region of a camera 110, the recording of the print surface of which is subjected to image processing. After the checking operation has been carried out the PrintCheck carousel 107 rotates back again into the starting position in which the checked CD is removed.

If the result of the operation of checking the print image is positive the CD is deposited on one of the four CD output plates 102, otherwise it is placed on the reject plate 106. At the same time, in a particular embodiment, it can be provided that when a defective overall print image is detected, which is generally caused by inadequate superimposition of the individual print images each produced by the application of a respective color, the ink printing head or heads in question is or are so displaced as to provide for optimum superimposition of the individual single-color print images. For that purpose, the individual ink printing heads are preferably supported displaceably in a plane, in which case the heads can be re-adjusted in respect of their position by a control means during operation of the apparatus, in response to the detected print error. Such re-adjustment can be necessary for example after a change in printing head.

The operation of picking up or depositing CDs in the input and output station 150 is carried out by a CD transfer device 120 mounted movably to a horizontal arm 124 of a portal assembly 122. Movement of the CD transfer device 120 takes place perpendicularly to the longitudinal extent of the carriages, for example the collecting carriage. The CD transfer device 120 is reciprocated stepwise in the direction of the arrow C, with the stepping distance being the same in both directions and corresponding to half the spacing of the center lines of the receivers 82, 92 of the collecting carriage and the separating carriage respectively. That stepping distance is identical to the spacing of the center lines of the separating carriage and the collecting carriage relative to the center line of the receiver of a transport carriage insofar as the latter is disposed with its holding plate in the parking position 140.

In order to be able to lift CDs off the individual plates or receivers of the carriages and deposit them at another location in a defined fashion, in the described embodiment the CD transfer device 120 has a total of twelve vacuum injectors with which the CDs can be picked up by suction. As can be seen from FIGS. 6 through 8, arranged in the central region of the transfer device are two rows of injectors 126, the rows being spaced just by the stepping distance of the CD transfer device. The injectors 126 serve for simultaneously lifting off the CDs which are arranged on one of the three carriages. The CDs which have been lifted off are deposited downwardly on an adjacent carriage after displacement of the CD transfer device by a stepping distance in the plane of the drawing. In that respect, in a single working step, the CDs arranged in the collecting carriage 80 can be picked up and deposited in the transport carriage 16a, 16b or the CDs arranged in the transport carriage can be picked up and deposited in the separating carriage 90.

Besides the two above-described rows each involving four vacuum injectors, the CD transfer device 120 has two further injectors on the plate-shaped base, in each of the input and output regions, one of each two injectors being pivotable. By virtue of the stepwise movement of the CD transfer device between two operating positions, associated with each individual vacuum injector is an individual location from which CDs are picked up and an individual location within the input and output station 150, at which CDs are deposited. Only the injector 126 which is fixed in the input region to the pivotal arm 128 and the injector 126 which is fixed in the output region to a pivotal arm 127 have two alternative deposit locations which are selected in accordance with the respective result of the IdentCheck operation or the operation of checking print quality.

FIG. 6 shows an operating situation in the input region, in which on the one hand a CD is deposited on the IdentCheck plate and the CD previously checked on the IdentCheck plate is deposited on the collecting carriage 80. In the output region the separating carriage 90 still has two printed CDs. The CD previously picked up by the separating carriage is laid on the PrintCheck plate 108a of the PrintCheck carousel 107, while at the same time the pivotal arm 127 deposits a CD which has been checked and given a positive result on a CD output plate 102 of the output carousel 100. After the CDs have been deposited as described above the collecting carriage 80 moves towards the right by one step and the separating carriage 90 moves towards the left by one step.

The CD transfer device 120 then moves cyclically upwardly in the Figs. by the described stepping distance, thus affording the operating situation shown in FIG. 7. The upper vacuum injector 126 in the input region is just picking up a CD from the CD input plate 72, while at the same time the vacuum injector 126 fixed to the pivotal arm 128 is picking up a CD from the IdentCheck plate 78. In the output region the outermost injector 126 on the pivotal arm 127 is picking up a CD which has been checked in respect of its print image while the adjacent vacuum injector is picking up a CD from the separating carriage 90.

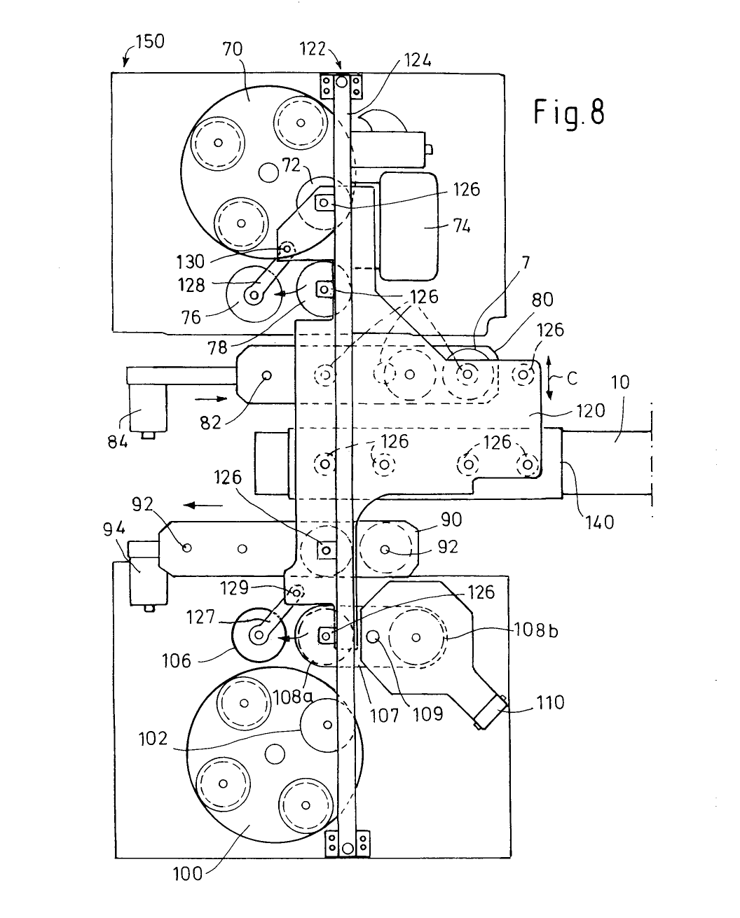

For the purposes of describing the deposit procedure it will now be assumed that both the IdentCheck on the IdentCheck plate 78 and also the operation of checking the print image of the CD picked up in the output region were negative. As shown in FIG. 8 therefore, the pivotal arm 128 pivots about its pivot axis 130 so that the reject CD can be deposited on the reject plate 76. The pivotal arm 127 pivots about its pivot axis 129 in the same manner so that the CD with defective printing thereon can be deposited on the reject plate 106.

If, however, the outcome of the operation of checking the identity of the input CD and the operation of checking the print quality on the output CD is positive, the result is the operating situation shown in FIG. 6. The CD transfer device can be cyclically moved downwardly by one step, in which case the checked input CD is deposited on the collecting carriage and the checked output CD is deposited on the output carousel.

In an embodiment which is not illustrated here, in operation of the CD transfer device 120, the pivotal arms 127, 128 do not pivot through about 90° as shown in FIG. 8 in the operation of depositing the reject article, but instead they pivot through about 180°. Accordingly, the CD transfer device also cyclically moves downwardly when depositing the reject article, so that at the same time, for example, a new CD can also be deposited on the IdentCheck plate 78.

The individual vacuum injectors of the CD transfer device in this described embodiment operate in a common plane, that is to say the CD transfer device also moves as described with a stepwise movement only in one plane. In order to move CDs on one of the CD input plates 72 from which CDs are removed into the receiving plane of the vacuum injector 126, the apparatus has a CD lifter 74. The described reciprocating movement of the CD transfer device can provide on the one hand in a single working step that a transport carriage which has been moved into the input and output station 150 is loaded with CDs to be printed and the printed CDs are removed. Subsequently, the separating carriage is then emptied and the collecting carriage loaded again so that the input and output station is in readiness again for the next incoming transport carriage.

The configuration according to the invention as described above affords a higher degree of flexibility in terms of the movement of the transport carriages both outside and also within the at least one decorating station, as the objects can be treated on different transport carriages in the same decorating stations, with the carriages being so designed that they can be guided past each other. By virtue of the improved flexibility in regard to the movement of the transport carriages, the throughput of the apparatus according to the invention can be increased in comparison with conventional apparatuses.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An apparatus for decorating objects, comprising
at least one decorating station,
at least first and second transport carriages,
a respective drive device adapted to displace each transport carriage,
a respective holder on each transport carriage and adapted to carry at least one object,
means for mounting the holder of at least one transport carriage thereto movable perpendicularly to the direction of movement of the transport carriage, and
carriage tracks on which the at least first and second transport carriages are respectively guided in mutually separate relationship in at least portion-wise manner.

2. The apparatus as set forth in claim 1, wherein carriage tracks for the transport carriages extend in parallel and mutually displaced relationship.

3. The apparatus as set forth in claim 1, wherein the carriage tracks are linear tracks, on each of which a respective individual carriage is guided.

4. The apparatus as set forth in claim 1, wherein a holder of a transport carriage is designed for holding a plurality of objects and comprises a respective receiver for each of the objects.

5. The apparatus as set forth in claim 4, wherein the plurality of object receivers in the holder is arranged in succession in the direction of movement of the transport carriage.

6. The apparatus as set forth in claim 5 including
a movable separating carriage having a plurality of object receivers arranged in succession in the direction of movement of the separating carriage, and
a transfer device operable to simultaneously pick up objects held in a holder of a transport carriage and simultaneously deposit same in the holder of the separating carriage.

7. The apparatus as set forth in claim 6 including
a movable collecting carriage having a holder with a plurality of object receivers arranged in succession in the direction of movement of the collecting carriage,
wherein the transfer device is operable to simultaneously pick up objects held in the holder of the collecting carriage and deposit them in the object receiver of the holder of the transport carriage.

8. The apparatus as set forth in claim 1, wherein the at least two decorating stations include printing stations arranged in succession in the direction of movement of a transport carriage.

9. The apparatus as set forth in claim 1, wherein the drive device of a transport carriage is a linear motor, wherein the transport carriage includes one of the primary and secondary parts of the linear motor.

10. The apparatus as set forth in claim 1, including a displacement device at least one transport carriage which provides two reversal positions and adapted to move at least one holder perpendicularly to the direction of movement of the transport carriage.

11. The apparatus as set forth in claim 10, wherein the displacement device includes a motor operable to displace the holder by way of a transmission with at least one position with a high and in particular infinitely high transmission ratio and lock it in at least one transmission position against a retroacting load on the holder.

12. The apparatus as set forth in claim 11, wherein the motor is a pneumatic pivotal drive.

13. The apparatus as set forth in claim 11, wherein the holder is adapted to operate near a reversal position at a speed which is low in comparison with the maximum displacement speed.

14. The apparatus as set forth in claim 4, including, energy storage means which is adapted in the movement of the holder between two reversal positions from one of the reversal positions of the holder to firstly deliver energy to the holder for the acceleration thereof and subsequently prior to reaching the other reversal position of the holder to receive energy from the holder for retardation thereof.

15. The apparatus as set forth in claim 14, wherein the energy storage means comprises a spring.

16. The apparatus as set forth in claim 4, including, energy storage means adapted to store potential energy when the holder is in a reversal position.

17. The apparatus as set forth in claim 1, comprising
an elongate base having first and second mutually opposite longitudinal sides,
a base guide at said sides, and
a guide on the transport carriage and co-operable with said base guide for establishing the carriage track for the transport carriage.

18. The apparatus as set forth in claim 1, wherein a transport carriage has a vertically extending base plate, a carrier arranged on the base plate displaceably in the plane of the base plate and perpendicularly to the direction of transport of the carriage, and a holding plate carried by the carrier and extending perpendicularly to the base plate of the transport carriage.

19. A method of decorating objects in which
at least first and second transport carriages are respectively moved by a drive device,
at least one respective object is held by a holder which is itself carried by the transport carriage,
the holder of at least one transport carriage is moved perpendicularly to the direction of movement of the carriage, and
the transport carriages are guided at least in portion-wise manner in mutually displaced relationship.

20. The method as set forth in claim 19, wherein the transport carriages are moved on carriage tracks which extend parallel and in mutually displaced relationship over the entire track length.

21. The method as set forth in claim 19, wherein a said transport carriage is driven independently of the at least one other transport carriage.

22. The method as set forth in claim 19, wherein a transport carriage is moved in both directions on a linear track during the decoration of the object.

23. The method as set forth in claim 19, wherein a plurality of objects is held by a holder of a transport carriage.

24. The method as set forth in claim 23, wherein the plurality of objects is introduced individually in separate working steps in succession into a holder of a movable collecting carriage and subsequently the plurality of objects is removed in a single working step from the holder of the collecting carriage and introduced into the holder of a transport carriage.

25. The method as set forth in claim 23, wherein after decoration of the objects the plurality of objects is removed in a single working step from the holder of the transport carriage and introduced into a holder of a separating carriage and wherein the plurality of objects is individually removed in separate working steps in succession from the holder of the separating carriage.

26. The method as set forth in claim 19, wherein an object is decorated successively in at least two decorating stations which are arranged in succession in the direction of movement of the object.

27. The method as set forth in claim 19, wherein an object is printed upon in the at least two decorating stations and wherein the printing ink is dried on the object after passing through a decorating station before it is printed on again in a following decorating station.

28. The method as set forth in claim 19, wherein the actual position of an object is detected and the movement of the associated transport carriage is adapted to a decorating operation in a decorating station.

29. The method as set forth in claim 19, wherein a plurality of objects are decorated in a holder of a transport carriage simultaneously in different decorating stations spaced from each other in the direction of movement of the transport carriage.

30. The method as set forth in claim 19, wherein the movement of a holder has perpendicularly to the direction of movement of the carriage at least one end position which is arrested during the decoration of objects held in the holder in a decorating station.

31. The method as set forth in claim 19, wherein a holder is moved relative to the transport carriage between first and second reversal positions.

32. The method as set forth in claim 19, wherein to assist with the movement of the holder energy is taken from an energy storage means and energy is fed to the energy storage means for retardation of the holder.
